(19) United States
(12) Patent Application Publication
(10) Pub. No.: US 2023/0177212 A1
(43) Pub. Date: Jun. 8, 2023

(54) VIDEO PRESENCE AND COLLABORATION

(71) Applicant: Joseph K. Sipher, San Francisco, CA (US)

(72) Inventor: Joseph K. Sipher, San Francisco, CA (US)

(21) Appl. No.: 18/073,497

(22) Filed: Dec. 1, 2022

Related U.S. Application Data
(60) Provisional application No. 63/285,431, filed on Dec. 2, 2021.

(51) Int. Cl. G06F 21/62; H04N 5/262; G10L 21/10

(52) U.S. Cl. CPC G06F 21/6254; H04N 5/262; G10L 21/10; H04L 65/4015

(57) ABSTRACT

A plurality of users, each using a dedicated individual computing device in their own physical space, can automatically and passively communicate with each other to provide live, clear, accurate presence information to each other, while maintaining better privacy than a standard video stream provides. A dynamic representation of presence may be implemented, for example, as a video presence stream, which may be intentionally pixelated and/or blurred so as to preserve privacy. Mechanisms are described to allow users to use such video presence streams to automatically and/or manually communicate current presence information to others within a group.

### CROSS-REFERENCE TO RELATED APPLICATION

The present application claims the benefit of U.S. Provisional Application Ser. No. 63/285,431 for “Methods and Platforms for Remote Video Presence and Collaboration”, filed on Dec. 2, 2021, which is incorporated by reference herein in its entirety.

### TECHNICAL FIELD

The present document relates to methods, techniques, and platforms for providing video presence information between users or individuals using connected computing devices without sacrificing privacy.

### BACKGROUND

In many contexts, it is useful for a user in a networked computing environment to be made aware of the presence and/or availability of other users with whom the user may have some sort of relationship, such as a collegial, workplace, professional, or personal relationship. Existing systems may indicate presence via an icon or static indicator, but generally fail to provide additional information regarding activities, availability, and energy of users. In particular, existing systems generally fail to provide any presence information that simulates or approximates a live view. Many existing systems also fail to provide accurate presence information because they rely on inherently inaccurate mechanisms such as keyboard activity monitoring, mouse activity monitoring, and/or device sleep.

### SUMMARY

According to various embodiments, the methods and techniques described herein enable a plurality of users, each using a dedicated individual device (such as a computing device, table, smartphone, or the like) in their own physical space, to communicate with each other including mechanisms for such users to passively provide live, clear, accurate presence information to each other, while maintaining better privacy than a standard video stream provides. The devices may be (but need not be) located remotely from one another.

In at least one embodiment, the systems and methods described herein may be implemented using a video presence and collaboration platform that provides a continuous video presence stream configured to depict a dynamic representation of the presence of a user while hiding or obscuring specific details that may violate the user's privacy. The representation may be more detailed than can be provided via a virtual or surrogate presence indicator such as a dot, icon, or the like. In one example, the dynamic representation of presence may be implemented as a video presence stream, which may be intentionally pixelated and/or blurred so as to preserve privacy. The degree to which pixelation and/or blur is applied may be customizable based on the degree of personalization desired. The video presence stream may be broadcast to other individuals who belong within a group, occupy a shared virtual space, and/or have some relationship with the user, such as those who are work colleagues, family members, friends, or other associates of the user. In some embodiments, the video presence stream may be made available only to authorized individuals; in other embodiments, it may be visible to anyone.

By using a pixelated and/or blurred video presence stream, transmitted via a communication network, the system is able to signal a user's presence (including, for example, their energy and availability to engage in tasks and/or communicate with other individuals) to others without unduly sacrificing the user's privacy. The system thus may enable any number of participants within a group or within a shared virtual space to ascertain one another's current availability, energy, and/or presence, and may communicate such information to others within the group or space in a manner that simulates a shared physical space such as an office or the like. The video presence stream may be configured so that others can see an animated representation of the user but cannot see certain details of the user such as facial expressions, lip movement, or background environment. This form of modified video presence stream may be referred to as an “Office with Frosted Glass” for the purposes of this description, because it communicates the user's availability in a manner that mimics a physical office environment in which the user has a personal office with a frosted glass door.

In at least one embodiment, the video stream may include an audio portion. The audio portion of the original video stream may be muted and broadcast only in a visual manner, such as via a numeric and/or visual (such as graphical) representation, to others within the group or virtual space. Such a technique allows others within the group or virtual space to get a sense of what is happening within the user's physical space without necessarily hearing the actual audio stream. One benefit of this technique is that it may communicate context for initiating a higher bandwidth video call or text communication between participants. Also, this technique may provide a mechanism by which users in the group or virtual space may feel closer to one another within a virtual space, while being physically separated from one another.

The described techniques may therefore help to create and/or reinforce, within a virtual space, a replication of certain characteristics of a physical group environment, such as an environment of a shared physical office space with individual cubicles or private offices.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a screenshot depicting an example of a user interface for a video presence and collaboration system according to one embodiment.

FIG. 2 is a screenshot depicting an example of a user interface for specifying available hours according to one embodiment.

FIG. 3A is a partial screenshot depicting examples of sharer and sharee control panels that may be displayed when a screen is being shared during a video call, according to one embodiment.

FIG. 3B depicts various examples of aspect ratio conversion when sharing screens, according to one embodiment.

FIG. 4 is a flow diagram depicting a method of generating, transmitting, and displaying a modified video presence stream, according to one embodiment.

FIG. 5 is a flow diagram depicting a method of generating, transmitting, and displaying a visual representation of audio, according to one embodiment.

FIG. 6 is a block diagram depicting a cloud-based network architecture for implementing a video presence and collaboration system according to one embodiment.

FIG. 7 is a block diagram depicting a software architecture for implementing a video presence and collaboration system according to one embodiment.

FIG. 8 is a block diagram depicting a hardware architecture for at least one component of the described system, according to one embodiment.

FIG. 9 is a block diagram depicting an overall system architecture for implementing a video presence and collaboration system according to one embodiment.

FIGS. 10A and 10B depict examples of application icons including badges having numeric indicators, as may be displayed according to one embodiment.

FIG. 11 depicts an example of a screen for inviting a user to a full-resolution video stream, according to one embodiment.

### DETAILED DESCRIPTION OF THE EMBODIMENTS

The systems and methods set forth herein may be applied in many contexts in which multiple users who may or may not be situated remotely with respect to one another may be communicatively connected with one another via an electronic network. In many such situations, it can be useful for users to view presence information about other users. Examples of such situations include a workplace, a family environment, a friend group, a shared virtual space, or any other group of individuals or entities. For ease of nomenclature, the term “group” will be used to apply to any such collection of individuals or entities who may be using the techniques described herein.

The described techniques can also be used in other contexts, and are not limited to the particular applications described herein. For example, the described techniques can be applied in any situation or context in which it may be useful to view presence information about other users. In addition, the particular hardware arrangements depicted and described herein are simplified examples for illustrative purposes.

In some embodiments, one or more components, as shown and described below in connection with various figures herein, may be used to implement the system and method described herein. In at least one embodiment, such components may be implemented in a cloud computing-based client/server architecture, using, for example, Amazon Web Services, an on-demand cloud computing platform available from Amazon.com, Inc. of Seattle, Wash. Therefore, for illustrative purposes, the system and method are described herein in the context of such an architecture. One skilled in the art will recognize, however, that the systems and methods described herein can be implemented using other architectures, such as for example a standalone computing device or a peer-to-peer architecture, rather than a client/server architecture.

Further, the functions and/or method steps set forth herein may be carried out by software running on one or more of the device 801, client device(s) 808, server(s) 901, and/or other components. This software may optionally be multi-function software that is used to retrieve, store, manipulate, and/or otherwise use data stored in data storage devices such as data store 806, and/or to carry out one or more other functions.

### Definitions and Concepts

For purposes of the description herein, a “user”, such as user 800 referenced herein, may typically be an individual, but may also refer collectively to a number of individuals, for example in a scenario where several individuals may be looking at or using the same device. A “group” may be a number of users who may be (but need not be) remotely located with respect to one another; typically, each user in the group may be using a different device and may view presence information about other users via the techniques described herein. In the context of the description herein, such a user or individual may also be referred to as a participant. A group may be (but need not be) associated with a family, workplace, company, department, physical location, affiliation, school, collegial entity, and/or the like. In at least one embodiment, members of the group may be considered to occupy a shared virtual space. For ease of nomenclature, the user whose presence information is being shared may be referred to herein as the “subject user.”

A “data store”, such as data store 806 referenced herein, may be any device capable of digital data storage, including any known hardware for nonvolatile and/or volatile data storage. A collection of data stores 806 may form a “data storage system” that can be accessed by multiple users. In at least one embodiment, data store 806 may be used to keep track of users and status, but video and audio data is not stored, for privacy reasons. A “computing device” or “device”, such as device 801 and/or client device(s) 808, may be any device capable of digital data processing, which may include, for example, a phone, smartphone, cellular phone, computer, laptop, kiosk, camera, tablet, or the like. In some embodiments, device 801 and/or client device(s) 808 may be a smart picture frame, television, or other device. A “server”, such as server 901, may be a computing device that provides data storage, either via a local data store, or via connection to a remote data store. A “client device”, such as client device 808, may be an electronic device that communicates with a server, provides output to one or more users, and accepts input from one or more users. “Presence information” may be any indication as to whether a user is present and/or available, and may include a video presence stream as described in more detail herein.

For purposes of the description herein, the functionality is set forth in terms of methods, techniques, and platforms for providing video presence information. However, such embodiments are merely exemplary; the techniques described herein may be implemented in connection with other types of presence information that may be shared among users, and the descriptions set forth herein should be considered to apply to any such alternative embodiments and contexts.

### System Architecture

According to various embodiments, the systems and methods described herein can be implemented on any suitable electronic device or set of interconnected electronic devices, each equipped to receive, store, and present information. Each electronic device may be, for example, a server, desktop computer, laptop computer, smartphone, tablet computer, and/or the like. The system can be implemented as a software application running on any such device or on any suitable combination or devices. Alternatively, the functionality described herein can be embedded in a hardware device, or built into any networked computing platform. In various embodiments, the system may employ various hardware components as described above, including for example, a camera, speakers, network/communications hardware, microphone, and/or the like, which may be integrated into the electronic devices or may be implemented as connected peripherals.

As described herein, some devices used in connection with the systems and methods described herein may be designated as client devices, which may be generally operated by end users. Other devices may be designated as servers, which generally conduct back-end operations and communicate with client devices (and/or with other servers) via a communications network such as the Internet. In at least one embodiment, the techniques described herein can be implemented in a cloud computing environment using techniques that are known to those of skill in the art.

In addition, one skilled in the art will recognize that the techniques described herein can be implemented in other contexts, and indeed in any suitable device, set of devices, or system having multiple devices in networked communication with one another. Accordingly, the following description is intended to illustrate various embodiments by way of example, rather than to limit scope.

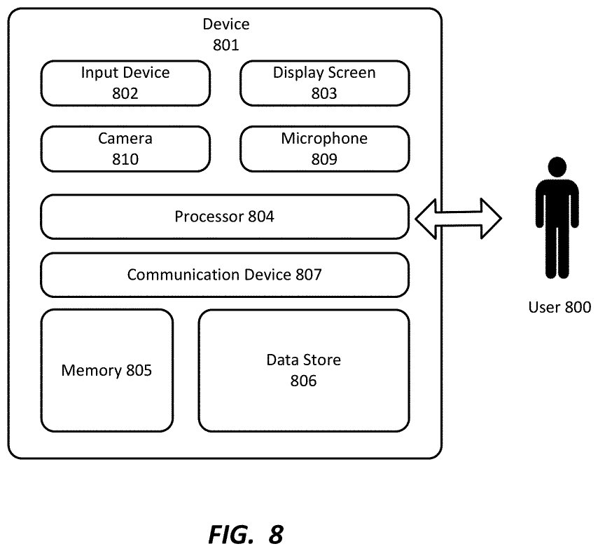

Referring now to FIG. 8, there is shown a block diagram depicting a hardware architecture for at least one component of the described system, according to one embodiment. Such an architecture can be used, for example, for implementing the techniques of the system in a computer or other device 801. Device 801 may be any electronic device. Any number of such devices 801 may be used in implementing the techniques described herein, and such devices 801 may be communicatively coupled with one another via any suitable means.

In at least one embodiment, device 801 includes a number of hardware components that are well known to those skilled in the art. Input device 802 can be any element that receives input from user 800, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 802 can be omitted or functionally combined with one or more other components.

Data store 806 can be any magnetic, optical, or electronic storage device for data in digital form; examples include flash memory, magnetic hard drive, CD-ROM, DVD-ROM, or the like. In at least one embodiment, data store 806 stores information that can be utilized and/or displayed according to the techniques described below. Data store 806 may be implemented in a database or using any other suitable arrangement. In another embodiment, data store 806 can be stored elsewhere, and data from data store 806 can be retrieved by device 801 when needed for processing and/or presentation to user 800. Data store 806 may store one or more data sets, which may be used for a variety of purposes and may include a wide variety of files, metadata, and/or other data.

In at least one embodiment, data store 806 may store data for enabling the video presence and collaboration techniques described herein. Data store 806 may also store preference data and the like, for use as described herein. In at least one embodiment, such data can be stored at another location, remote from device 801, and device 801 can access such data over a network, via any suitable communications protocol.

In at least one embodiment, data store 806 may be organized in a file system, using well known storage architectures and data structures, such as relational databases. Examples include Oracle, MySQL, and PostgreSQL. Appropriate indexing can be provided to associate data elements in data store 806 with each other. Metadata associated with configuration data, and defining configuration templates and layers, may be stored in such databases using any suitable data format(s). In at least one embodiment, data store 806 may be implemented using cloud-based storage architectures such as NetApp (available from NetApp, Inc. of Sunnyvale, Calif.) and/or Google Drive (available from Google, Inc. of Mountain View, Calif.).

Data store 806 may be local or remote with respect to the other components of device 801. In at least one embodiment, device 801 may be configured to retrieve data from a remote data storage device when needed. Such communication between device 801 and other components can take place wirelessly, by Ethernet connection, via a computing network such as the Internet, via a cellular network, or by any other appropriate communication systems.

In at least one embodiment, data store 806 may be detachable in the form of a CD-ROM, DVD, flash drive, USB hard drive, or the like. Information can be entered from a source outside of device 801 into a data store 806 that may be detachable, and later displayed after the data store 806 is connected to device 801. In another embodiment, data store 806 may be fixed within device 801.

In at least one embodiment, data store 806 may be organized into one or more well-ordered data sets, with one or more data entries in each set. Data store 806, however, can have any suitable structure. Accordingly, the particular organization of data store 806 need not resemble the form in which information from data store 806 may be displayed to user 800 on display screen 803. In at least one embodiment, an identifying label may also be stored along with each data entry, to be displayed along with each data entry.

Display screen 803 can be any element that displays information such as video streams, images, text, and/or graphical elements. In particular, display screen 803 may present a user interface for controlling and operating the video presence and collaboration techniques herein, and may also be used to display video presence information about other users. In at least one embodiment where only some of the desired output may be presented at a time, a dynamic control, such as a scrolling mechanism, may be available via input device 802 to change which information is currently displayed, and/or to alter the manner in which the information is displayed. In at least one embodiment, as described in more detail below, multiple display screens 803 may be provided; for example, an auxiliary display screen 803 may be used to present video presence information, while a main display screen 803 may be used for presenting other information such as full-resolution video calls.

Processor 804 may be a conventional microprocessor for performing operations on data under the direction of software, according to well-known techniques. In at least one embodiment, processor 804 may be used for generating a video presence stream to be transmitted to other devices, and/or for processing an incoming video presence stream for display on screen 803. Processor 804 may also be used for interpreting user input provided via input device 802, and for controlling the operation of the video presence stream system described herein. Memory 805 can be random-access memory, having a structure and architecture as are known in the art, for use by processor 804 in the course of running software.

Communication device 807 may communicate with other computing devices through the use of any known wired and/or wireless protocol(s). For example, communication device 807 may be a network interface card (“NIC”) capable of Ethernet communications and/or a wireless networking card capable of communicating wirelessly over any of the 802.11 standards. Communication device 807 may be capable of transmitting and/or receiving signals to transfer data and/or initiate various processes within and/or outside device 801, including signals representing video streams and/or other presence information. In particular, communication device 807 may communicate with other components described herein, for transmitting and receiving video presence streams.

Camera 810 may be used to capture images and/or video of user 800 and/or their environment, as described in more detail herein. Microphone 809 may be used to capture audio of user 800 and/or their environment. Camera 810 and/or microphone 809 may be integrated components of device 801, or they may be separate components that communicate with device 801 using any known techniques.

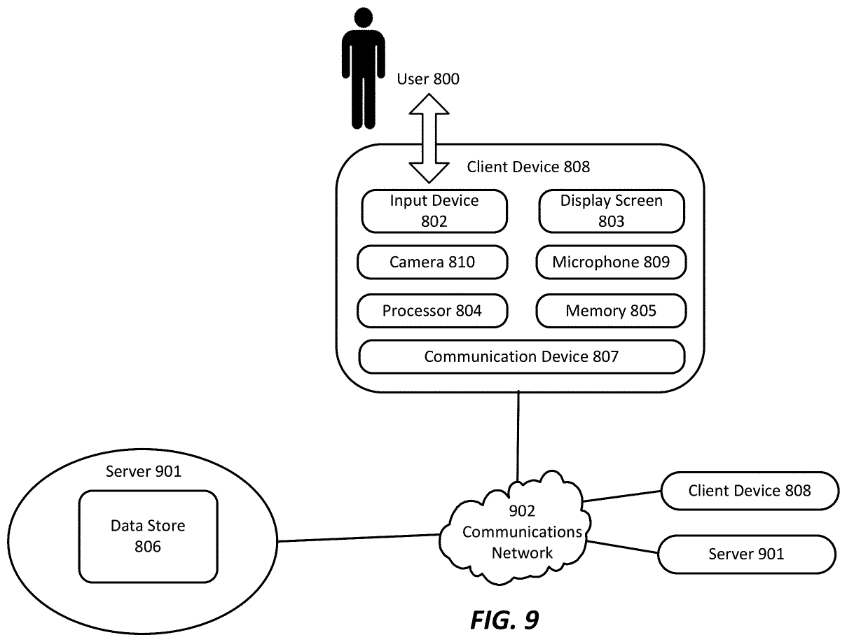

Referring now to FIG. 9, there is shown a block diagram depicting an overall system architecture for implementing a video presence and collaboration system according to one embodiment. Such an implementation may use a “black box” approach, whereby data storage and processing may be done completely independently from user input/output. An example of such a client/server environment is a web-based implementation, wherein one or more client device(s) 808 run(s) a browser that provides a user interface for interacting with web pages and/or other web-based resources from one or more server(s) 901. Video streams and other data from other devices, sources, and/or components (such as server(s) 901 or other client device(s) 808) can be presented as part of such web pages and/or other web-based resources, using known protocols and languages such as Hypertext Markup Language (HTML), Java, JavaScript, and the like.

Client device(s) 808 can be any electronic device(s) incorporating input device 802, display screen 803, camera 810, and/or microphone 809, such as a desktop computer, laptop computer, personal digital assistant (PDA), cellular telephone, smartphone, music player, handheld computer, tablet computer, kiosk, game system, wearable device, or the like. In at least one embodiment, client device(s) 808 may be an electronic picture frame having a camera, or a television or other electronic appliance having a camera, or a video wall, or the like. In yet another embodiment, client device(s) 808 may be a camera itself, which may be hand-held, tabletop, mounted, or the like, and may be stand-alone or a component of another device. Any suitable type of communications network 902, such as the Internet, can be used as the mechanism for transmitting data among client device(s) 808, server(s) 901, and/or other components described herein, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), Web Real-Time Communication (WebRTC), User Datagram Protocol (UDP), and/or the like, and/or any combination thereof. Any of a number of protocols can be used for managing video flow, including for example Web Services Security (WSS), Secure Real-time Transport Protocol (SRTP), Session Traversal Utilities for NAT (STUN), and/or Traversal Using Relays around NAT (TURN). In at least one embodiment, client device(s) 808 may transmit requests for data via communications network 902, and may receive responses from server 901 containing the requested data. Such requests may be sent via HTTP as remote procedure calls or the like.

In one implementation, server(s) 901 may be responsible for data storage and processing, and may incorporate data store 806. Server(s) 901 may include additional components as needed for retrieving data from data store 806 in response to requests from client device(s) 808.

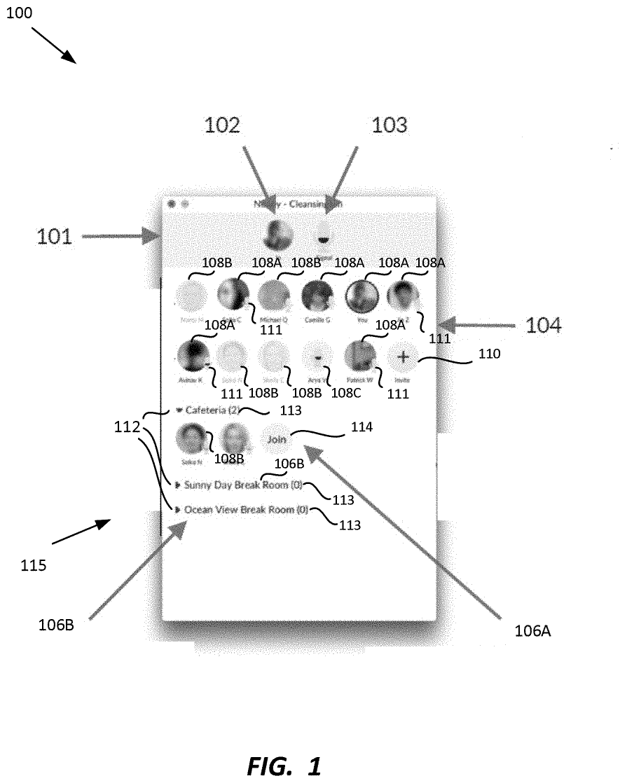

As described above in connection with FIG. 8, data store 806 may be organized into one or more well-ordered data sets, with one or more data entries in each set. Data store 806, however, may have any suitable structure, and may store data according to any organization system known in the information storage arts, such as databases and other suitable data storage structures. As in FIG. 1, data store 806 may store data for enabling the video presence and collaboration techniques described herein.

In addition to or in the alternative to the foregoing, data may also be stored in a data store 806 that is part of client device 808. In some embodiments, such data may include elements distributed between server(s) 901 and client device(s) 808, as well as other computing devices, in order to facilitate secure and/or effective communication between these computing devices.

As discussed above in connection with FIG. 8, display screen 803 can be any element that displays information such as video streams, images, text, and/or graphical elements. Various user interface elements, dynamic controls, and/or the like may be used in connection with display screen 803.

As discussed above in connection with FIG. 8, processor 804 can be a conventional microprocessor for use in an electronic device to perform operations on data under the direction of software, according to well-known techniques. Memory 805 can be random-access memory, having a structure and architecture as are known in the art, for use by processor 804 in the course of running software. A communication device 807 may communicate with other computing devices through the use of any known wired and/or wireless protocol(s), as discussed above in connection with FIG. 8.

Notably, multiple servers 901 and/or multiple client devices 808 may be networked together, and each may have a structure similar to those of client device(s) 808 and server(s) 901 that are illustrated in FIG. 9. The data structures and/or computing instructions used in the performance of methods described herein may be distributed among any number of client devices 808 and/or servers 901. As used herein, “system” may refer to any of the components, or any collection of components, from FIGS. 8 and/or 9, and may include additional components not specifically described in connection with FIGS. 8 and 9.

In some embodiments, data within data store 806 may be distributed among multiple physical servers. Thus, data store 806 may represent one or more physical storage locations, which may communicate with each other via the communications network and/or one or more other networks (not shown). In addition, server(s) 901 as depicted in FIG. 9 may represent one or more physical servers, which may communicate with each other via communications network 902 and/or one or more other networks (not shown).

In one embodiment, some or all components of the system can be implemented in software written in any suitable computer programming language, whether in a standalone or client/server architecture. Alternatively, some or all components may be implemented and/or embedded in hardware.

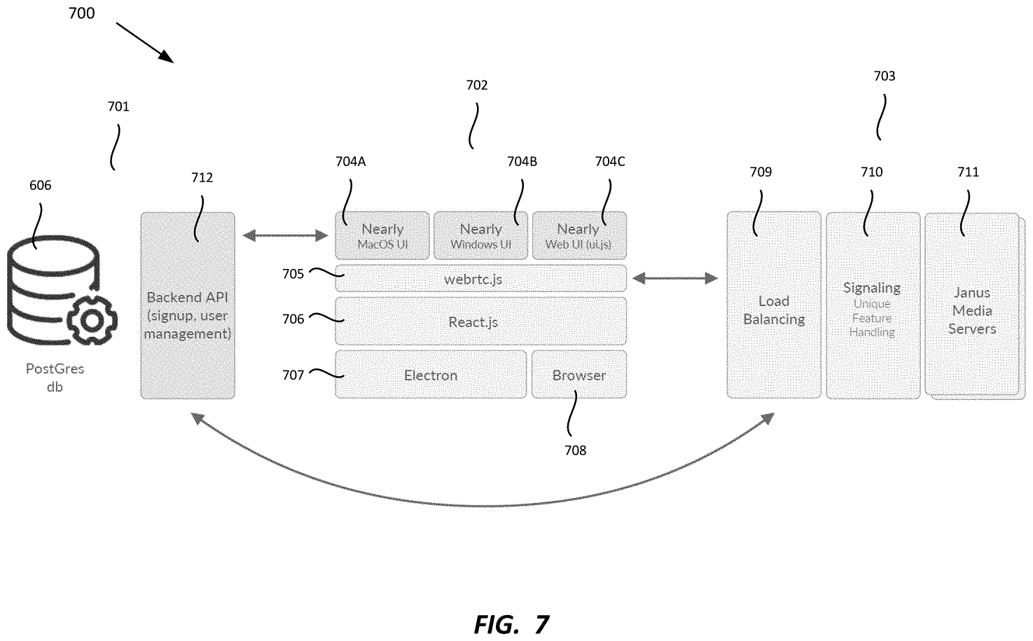

Referring now to FIG. 7, there is shown a block diagram depicting a software architecture 700 for implementing a video presence and collaboration system according to one embodiment. Back-end software 701, which may run on one or more server(s) 901, may include an application programming interface (API) 712 used for signup, user management, security, and/or the like, and may access database 606 as needed. Client software 702 may run on client devices 808, and may include, for example:

Front-end software 704A, 704B, and/or 704C for presenting a user interface via display screen 803 on client device 808 and for receiving user input via input device 802;

Webrtc.js code 705 for calling Web Real-Time Communication (WebRTC) software 703;

React.js code 706 for building and implementing the user interface presented in 704A, 704B, and/or 704C;

Electron code 707, which may be a development environment that may be used to build a desktop application for multiple platforms from a single code base, for implementing the techniques described herein; and/or

Browser 708 for running web-based code for implementing the techniques described herein.

Webrtc.js code 705 may communicate with WebRTC software 703, which may run on client device 808, or on server(s) 901, or on some other device, or on some combination thereof. WebRTC software 703 may include, for example:
WebRTC load balancing code 709 that verifies that if one user is calling another, they are on the same Janus server.
Janus media servers 711, which are scalable WebRTC servers that handle video streams in a very efficient way using the WebRTC standard.
Signaling code 710, for handling video and audio features unique to the video presence system that are not included in the standard WebRTC servers. These include handling the pixelated/shrunken video and the serialized audio as well as the back-end aspects of application level features like multi-party calling, public spaces and the like.

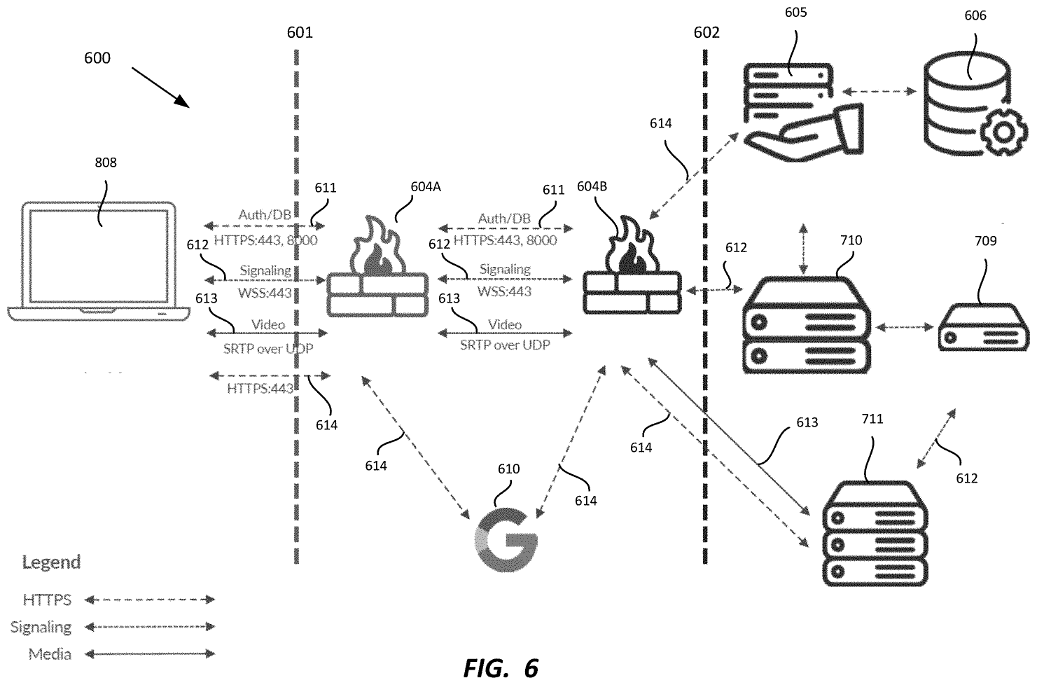

Referring now to FIG. 6, there is shown a block diagram depicting a cloud-based network architecture 600 for implementing a video presence and collaboration system according to one embodiment. In at least one embodiment, communication among the components depicted in FIG. 6 may take place over a network 902 (not shown in FIG. 6) such as the Internet or any other suitable network, using any suitable protocols as may be known in the art. The benefits of using a cloud-based approach include the ability to scale quickly and support a variety of different customers in one easily managed place. Alternatively, the infrastructure for implementing and hosting the video presence and collaboration system may be implemented in-house, which may be preferable in some situations for security and control reasons.

In at least one embodiment, architecture 600 includes some components that may be implemented within enterprise/ISP network 601 and other components that may be implemented within back-end infrastructure 602, which may be cloud-hosted. One or more firewall(s) 604A, 640B can be used to ensure security.

Client device 808 may be, for example, an enterprise-owned laptop computer running a software application (“app”) for handling client-side operations of the described system. Client device 808 may transmit and receive authentication info 611, signaling info 612, video 613, and/or other HTTPS data over a network 902 such as the Internet (not shown in FIG. 6) via client-side firewall 604A and server-side firewall 604B using known protocols. HTTPS data 614 may be transmitted via Google Backup Session Traversal Utilities for NAT (STUN) server 610.

In at least one embodiment, back-end infrastructure 602 may be packaged into a Docker bundle or similar technology. Back-end infrastructure 602 may include various components for implementing server-side operations, such as for example:
Front-end software 605;
Database 606;
Signaling module 607;
Load balancer 709; and
Server cluster 711.

In another embodiment, the system may be implemented as a peer-to-peer system without a central server. In yet another embodiment, the system may be implemented as a peer-to-peer or serverless system so as to further distribute CPU usage and potentially improve security.

### Video Presence Stream

In at least one embodiment, the system generates and transmits, for at least one user (referred to herein as “subject user 800”), a video presence stream configured to depict a dynamic representation of presence of the subject user while hiding specific details that may violate or impinge on the subject user's privacy. The video presence stream can be made available to other members of the subject user's group, or to selected users as designated by the subject user, or to the general public, as appropriate and desired.

In at least one embodiment, the continuous video presence stream may be a video stream captured by camera 810 that depicts subject user 800. The continuous video presence stream may be modified (for example by pixelation and/or blurring) so as to preserve the privacy of subject user 800. In at least one embodiment, the degree of pixelation and/or blur (and/or other modification) may be adjusted so as to provide more or less detail. In this manner, the described system communicates presence, energy, and availability of subject user 800 without sacrificing privacy.

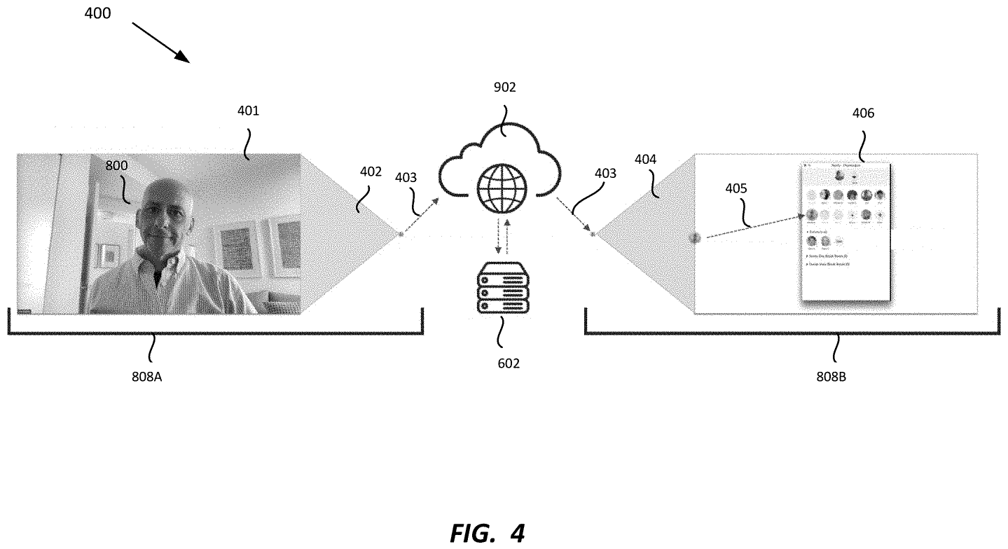

Referring now to FIG. 4, there is shown a flow diagram depicting a method 400 of generating, transmitting, and displaying a modified video presence stream, according to one embodiment. Two client devices are depicted: sending device 808A and receiving device 808B. Upon activation, camera 810 on sending device 808A may continuously capture video 401 depicting subject user 800. In step 402, video 401 may be resized and cropped to a very small size (for example from 1280×720 pixels to 15×15 pixels); in addition, the frame rate of video 401 may be slowed, for example from 30 frames per second to 5 frames per second. The reduction in size and/or frame rate may be performed by processor 804 on sending device 808A, or by a processor at some other location. Reducing size and/or frame rate may provide several benefits, including for example: a) the modified video requires less bandwidth and processing power than does full-resolution video; b) the modified video communicates basic movement and shapes without providing excessive detail; and c) privacy may be maintained, since the full-resolution video never leaves sending device 808A. Other methods may also be used, including any suitable technique for blurring and/or pixelating the original video. For example, a hardware device such as a translucent camera cover or filter may be deployed over camera 810 so as to blur the video by optical means. When a full-resolution video call is initiated, such hardware blurring device can be either automatically or manually be set to allow full video, or it can be temporarily removed. In further embodiments, an animated avatar may be automatically generated based on the content of video 401, and may be used in place of blurred video. The avatar may be selected by subject user 800, and may be automatically animated to represent general movements of subject user 800, without replicating exact details that may intrude on subject user's 800 privacy.

In step 403, the resized video may be transmitted over communications network 902 (such as the Internet) to receiving device 808B. In at least one embodiment, such transmission may take place via back-end infrastructure 602, which may perform certain processing operations as desired, before routing the video to receiving device 808B.

Once received at receiving device 808B, in step 404 the video may be upsized to a suitable size, such as for example 48×48 pixels, so that it may be more easily readable by user 800 of receiving device 808B. Optionally, the video may be processed and/or converted to a desired format, for example by converting it to black-and-white (for uniformity), and/or by adding Gaussian blur. This upsizing, processing, and/or conversion may be performed by processor 804 on receiving device 808B, or by a processor at some other location. In addition, in step 405, the video may be sized so that it may be displayable within user interface 406 shown on display screen 803 of receiving device 808B.

As described above, in at least one embodiment, some of the processing of the video stream may be performed by processor 804 on sending device 808A, while other processing may be performed by processor 804 on receiving device 808B, thus spreading CPU load out to the edges of the network, and providing a more robust, less costly implementation. In other embodiments, such processing may take place at other locations, including (at least in part) at back-end infrastructure 602.

In another embodiment, the video may be sent to a server 901 as a series of small bitmap files having any suitable resolution (such as 15×15 pixels). The bitmap files may be sent in a compressed format, such as for example .jpg or .png, and they may be sent at any desired frequency, such as a few times a second. Receiving computing device 808B can then download the latest bitmap file at a suitable frequency, such as every few hundredths of a second. Such an embodiment may be advantageous in some situations, since it may require less processing power and may not require the use of any WebRTC media servers.

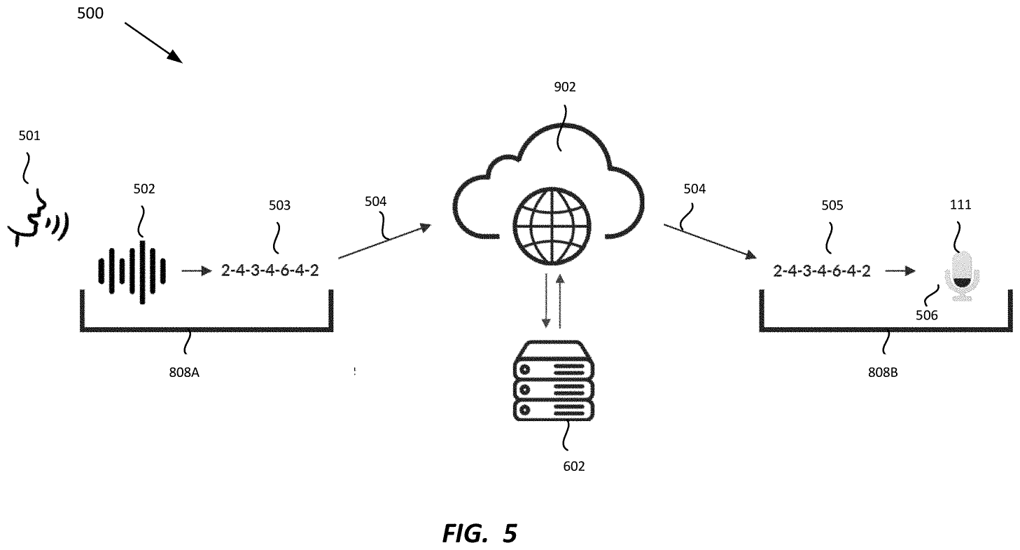

In at least one embodiment, the video stream may include an audio portion. The audio portion of the original video stream may be muted and broadcast only in a visual manner, such as via a numeric, visual, or graphical representation, to others within the group or virtual space. Referring now to FIG. 5, there is shown a flow diagram depicting a method 500 of generating, transmitting, and displaying a visual representation of audio (referred to herein as a “signal indicator 111”), according to one embodiment.

Two client devices are depicted: sending device 808A and receiving device 808B. Upon activation, microphone 809 on sending device 808A may continuously capture audio 501 (such as speech or the like) generated by subject user 800. Such audio 501 may be represented, in step 502, as a digital audio file. In step 503, the digital audio may be converted to numeric values representing sound; the numeric values may represent, for example, volume level, pitch, timbre, and/or other aspects of the sound. The conversion to numeric values may be performed by processor 804 on sending device 808A, or by a processor at some other location. Conversion to numeric values may provide several benefits, including for example: a) using less bandwidth and processing power than would a full audio file; b) the numeric values may communicate basic characteristics of the audio without providing excessive detail; and c) privacy may be maintained, since the full audio stream never leaves sending device 808A. Other methods may also be used, including any suitable technique for converting the audio to numeric, visual, graphical, or other format.

In at least one embodiment, so as to further protect privacy, the numeric values may be configured so that they cannot be reverse-engineered to recreate the original audio.

In step 504, the numeric values representing the captured audio may be transmitted over communications network 902 (such as the Internet) to receiving device 808B. In at least one embodiment, such transmission may take place via back-end infrastructure 602, which may perform certain processing operations as desired, before routing the numeric values to receiving device 808B.

In step 505, receiving device 808B may receive the numeric values. In step 506, receiving device 808B may convert the received numeric values into a visual or graphical indicator, such as signal indicator 111 that depicts a microphone that dynamically changes in appearance to reflect a current sound level. For example, the microphone-shaped signal indicator 111 depicted in FIG. 5 contains a black area that may change in appearance dynamically by filling up more of the microphone when the volume is higher, and less of the microphone when the volume is lower. Signal indicator 111 may alternatively take any other form, such as a bar graph, dynamic level indicator, or the like. It may be a static image or a dynamic visual indicator that may represent volume, pitch, and/or any other characteristic of captured audio 501. Other types of signal indicator 111 may also be used, such as animations, expanding circles, or the like. In at least one embodiment, signal indicator 111 may graphically represent the numeric values. For example, if the scale of the numeric values is 0 to 9, then signal indicator 111 may have 10 graphical levels to accurately reflect the volume of sound captured by microphone 809 on sending device 808A.

### User Interface

Referring now to FIG. 1, there is shown a screenshot depicting an example of a user interface 100 for a video presence and collaboration system according to one embodiment. User interface 100 may be presented, for example, on display screen 803 of sending client device 808A and/or receiving client device 808B. In at least one embodiment, user interface 100 may include designated selfie area 101 and general area 104. In at least one embodiment, user interface 100 may provide presence information for a number of users who occupy a shared virtual space.

In at least one embodiment, sending device 808A may display, for subject user 800, a “selfie video” 102 that shows subject user 800, in real-time, the appearance of the modified video presence stream being generated from the video of subject user 800, as it may be presented to other users 800. Selfie video 102 may be, for example, the modified video presence stream generated using method 400 described above.

In at least one embodiment, sending device 808A may display, for subject user 800, signal indicator 103 that shows subject user 800, in real-time, the appearance of signal indicator 111 being generated from the audio of subject user 800 using method 500 described above, as it may be presented to other users 800.

In at least one embodiment, selfie video 102 and signal indicator 103 may be shown in designated selfie area 101 of user interface 100. In another embodiment, selfie area 101 may be omitted, and selfie video 102 and/or signal indicator 103 may be displayed in general area 104 of user interface 100, optionally labeled with “You” or another appropriate label.

In at least one embodiment, selfie area 101 and general area 104 can be presented as part of common pane 115 (or window) on display screen 803 of device 801. Alternatively, selfie area 101 and general area 104 can be presented in separate panes or windows on display screen 803 of device 801; alternatively one or the other of selfie area 101 and general area 104 can be omitted from the display.

In at least one embodiment, users 800 can set their status to indicate their availability to others, and/or to specify how their video stream should appear to others. Example status settings may include “in” (indicating that user 800 is available), “out” (indicating that user 800 is not available), or “no video”, which indicates availability without video. In addition, users 800 may specify text, icons, and/or other indicators to be displayed on others' devices 808 to provide more information as to user's 800 availability.

FIG. 1 depicts some examples of such status indicators 108. Indicators 108A may indicate that user 800 has specified an “in” status; in the example of FIG. 1, indicators 108A show live blurred video. Indicators 108B may indicate that user 800 has specified an “out” status; in the example of FIG. 1, indicators 108B are grayed out and do not show any live video. Indicator 108C may indicate that user 800 has specified a “no video” status; in the example of FIG. 1, indicator 108C takes the form of an enlarged signal indicator, which functions similarly to signal indicator 111 as described in more detail below. In at least one embodiment, such indicators 108A, 108B, 108C may be shown within general area 104 of user interface 100. Specific indicators 108 depicted and described herein are merely examples; one skilled in the art will recognize that other indicators can be used to indicate user status, and that such indicators can take on any suitable form or appearance.

Indicators 108A, 108B, 108C thus allow user 800 to quickly ascertain the actual status or availability of anyone else in the group or virtual space. This helps answer questions like: “Are they in front of their computer?”; “Is their computer on, but they aren't there?”; and/or “Is there noise happening on their side or is it silent?” Indicators 108A, 108B, 108C also communicate an energy of activity for each represented individual, while preserving privacy.

In at least one embodiment, user interface 100 may also include invite icon 110, allowing user 800 to invite other users 800 to the group or virtual space so that their status can be displayed.

In at least one embodiment, some indicators 108 may include signal indicators 111, which may contain a visual representation of that user's 800 audio. As shown in FIG. 1, such signal indicators 111 may be presented as a microphone or other suitable shape, with a dynamic level representing the current volume of audio.

In at least one embodiment, general area 104 may contain indicators 108 for users 800 that belong to the group or virtual space along with subject user 800. General area 104 may thus allow subject user 800 (and other users 800) in the group or virtual space to quickly see who is present (or available), who may be busy, and who is not present (or available).

In at least one embodiment, the order in which users 800 are presented or displayed in general area 104 may be fixed for all users 800 in the group or virtual space. For example, user Jin Z. may be presented in the rightmost position within the top row of general area 104 for all users 800 within the group or virtual space. One advantage of having a fixed order for users 800 in the group or virtual space is that muscle memory will develop around users 800 and locations, thereby helping create the kind of stability that can occur in a physical space.

In at least one embodiment, other indicators of user availability may be presented within user interface 100; such indicators may be generated automatically or generated in response to user 800 input. Examples of automatically generated indicators, not shown in FIG. 1, may include:
“In a meeting” indicator, which may be generated automatically based on a user's 800 calendar;
“On a video call” indicator, which may be generated automatically based on a user's 800 calendar or by detecting that user 800 is on a video call such as a Zoom meeting or the like;
“Typing” indicator, which may be generated when user 800 is typing on the (virtual or physical) keyboard of their device.

In at least one embodiment, when user 800 is not on any high-resolution video call, a lock icon or other indicator (not shown in FIG. 1) may be displayed in selfie area 100 or elsewhere, indicating that user's 800 full video and sound are not leaving their device 808. Explanatory text associated with this lock icon can be made available, for example in response to user 800 hovering over it, clicking it, or otherwise activating the lock icon; such explanatory text may describe how and why user's 800 video and audio privacy are being maintained. In at least one embodiment, when a full-resolution video is started (for example if user 800 initiates or joins a video call), the lock icon or other indicator may change to an unlock or open status, or it may disappear, indicating to user 800 that their video and audio are being broadcast.

In at least one embodiment, in addition to general area 104, certain other areas of user interface 100 may be included, and may correspond to certain defined subgroups and/or public spaces. In this manner, the system may be able to replicate, in a virtual environment, the opportunity to facilitate ad hoc, spontaneous connections between people that share a physical space. Accordingly, user interface 100 may include virtual public spaces 106 that correspond to physical public spaces such as, for example, a cafeteria, hallways, a break room, an area near a coffee machine or water cooler, or the like.

In at least one embodiment, public spaces 106 as displayed in user interface 100 can be expanded or collapsed as desired. When in the expanded state (such as public space 106A), indicators 108 for those users 800 within the corresponding space may be displayed. When in the collapsed state (such as public spaces 106B), indicators 108 for those users 800 within the corresponding space may not be displayed. In at least one embodiment, user 800 can expand or collapse public spaces by tapping or clicking on arrow 112, which may change orientation to indicate whether a public space 106 is in an expanded or collapsed state. In at least one embodiment, population indicator 113 may be shown, indicating how many users 800 are currently in the corresponding public space 106.

In at least one embodiment, user 800 may join a public space 106 by dragging their avatar or selfie video 102 to the onscreen public space 106. In at least one embodiment, join icon 114 may be displayed; tapping or clicking on join icon 114 may allow user 800 to join the corresponding public space 106. In at least one embodiment, once user 800 has joined a public space 106, others within that public space 106 may be notified. In at least one embodiment, joining public space 106 does not impact the privacy mechanisms described herein with regard to how users 800 can view one another. In at least one embodiment, joining a public space 106 may optionally automatically start a multi-party video call among all users 800 currently in the public space 106, according to techniques described herein.

In at least one embodiment, the number of users 800 who may occupy a public space 106 may be limited. Users 800 who wish to join a public space 106 that is at capacity may be denied entry to the public space 106. In at least one embodiment, a virtual waiting room may be provided for users 800 who are waiting to join a public space 106.

In at least one embodiment, a user 800 can occupy multiple public spaces 106 at the same time. In other embodiments, a user 800 may only be permitted to occupy a single public space 106 at a time.

In at least one embodiment, a limit may be imposed on the number of users 800 permitted to simultaneously occupy the shared virtual space. In this manner, the system may avoid overwhelming users 800 with too many participants, and may help to maintain a level of privacy. If appropriate, therefore, in a large company or other entity, it may be feasible to provide multiple groups or virtual spaces (for purposes of the described system) for the overall entity; for example, a large corporation may provide a separate group or virtual space for each department or geographic region. In at least one embodiment, when there may be multiple groups or virtual spaces for an entity such as a corporation, public spaces 106 may be shared across multiple groups, so as to allow broader contact with members of different groups while maintaining the controlled nature of a smaller group size.

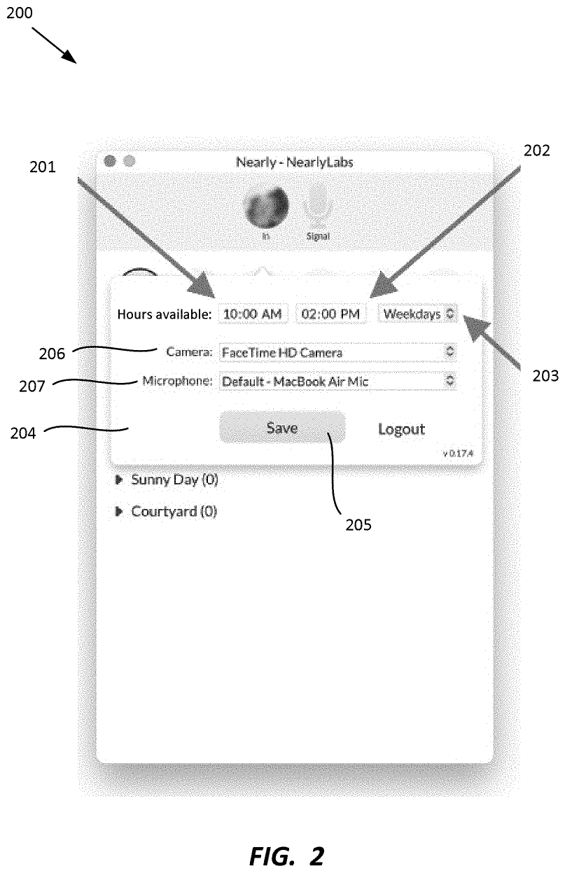

In at least one embodiment, user 800 can specify that their presence information should only be made available to other users at certain times of day, and/or on certain days of the week. FIG. 2 is a screenshot depicting an example of a user interface 200 for specifying available hours according to one embodiment. In at least one embodiment, presence information for user 800 may only be made available to other users during the specified times and days of the week.

In at least one embodiment, user 800 activates pane 204 by tapping on a control or otherwise specifying that they wish to configure the system. User 800 may then specify a start time in field 201, an end time in field 202, and day(s) of the week in field 203. Other selectors 206, 207 may be provided for specifying the camera and/or microphone to be used, respectfully. User 800 may click on Save button 205 to save the specified information.

One skilled in the art will recognize that the particular user interface 200 depicted in FIG. 2 is merely exemplary, and that any other suitable mechanism, display, or interface can be used for specifying the times and/or days during which presence information of user 800 should be made available to others. For example, in at least one embodiment, user 800 can specify any number of time periods in any number of days or dates.

In at least one embodiment, during the specified hours on the specified days, user's 800 presence information may be made available to other individuals in the group or virtual space. For example, during these times and days, an indicator 108A representing user 800 may be displayed on other devices to indicate that user 800 has an “in” status. During other times and days, an indicator 108B representing user 800 may be displayed on other devices to indicate that user 800 has an “out” status. In at least one embodiment, user 800 can manually override the status currently being shown, and/or can specify that the status should change automatically the next time a specified time period begins or ends (or user 800 can specify that the manually selected status should not be changed until user 800 specifies another change).

### Initiating Full-Resolution Video Calls

In at least one embodiment, any user 800 within a group or virtual space may interact with interface 100 to initiate full-resolution video calls with other user(s) 800 in the group or virtual space, for example by clicking, tapping, selecting, or otherwise interacting with at least one indicator 108 on interface 100. Such action may specify that user 800 (the “initiator”) wishes to initiate a video call with another user 800 (the “recipient”) represented by that indicator 108. In at least one embodiment, inviting the recipient to participate in a full-resolution video call may be referred to as “knocking” the recipient, consistent with the metaphor of knocking on a door within a physical office wherein participants occupy offices having frosted glass. In essence, the act of initiating a full-resolution video call in the context of the system described herein may be considered analogous to starting a face-to-face conversation in a physical office environment.

In at least one embodiment, once the initiator has knocked the recipient to invite the recipient to participate in a full-resolution video call, the recipient may be given an opportunity to accept or reject the invitation (i.e., to “answer”or “decline” the knock). While this invitation is pending, a scaled-up (for example 400×400 pixel) video window may be presented on display screens 803 of devices 808 of both the initiator and the recipient. However, until the recipient accepts the invitation to the full-resolution video call, the video stream displayed within the scaled-up video window may continue to be presented as blurred video as described above in connection with indicators 108A of FIG. 1. Links or buttons may be displayed to give the recipient an opportunity to accept or reject the invitation. In at least one embodiment, the full-resolution video stream may not be displayed until the recipient accepts the invitation (i.e., “answers” the knock). In this manner, privacy of both the initiator and the recipient can be maintained until the called user accepts the invitation.

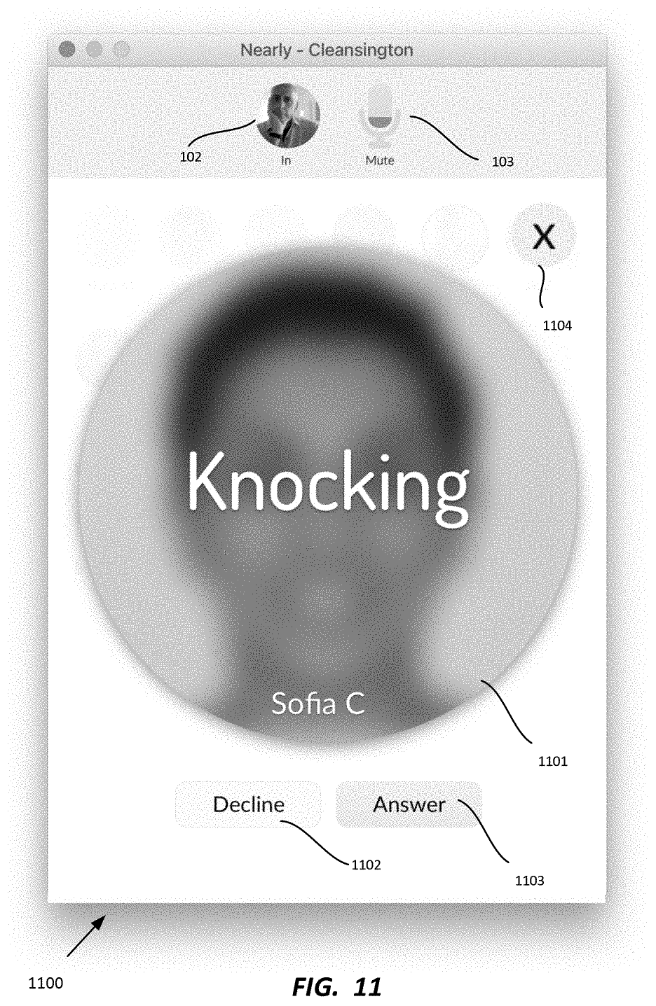

Referring now to FIG. 11, there is shown an example of a screen 1100 for inviting a user to a full-resolution video stream, according to one embodiment. Enlarged blurred video 1101 is shown to preserve the privacy of the calling party. Decline button 1102 declines the invitation and dismisses the screen. Answer button 1103 answers the invitation and initiates the full-resolution video call. Dismiss button 1104 dismisses the invitation screen without answering or declining the invitation.

If the recipient accepts the invitation, a two-way video call with full-resolution video and sound may be initiated between the two users 800. Before and/or during the call both the initiator and recipient may have the option to change their audio status (for example muted/not muted) and/or to change their video status (for example video/no video).

In at least one embodiment, if the recipient declines the invitation, the scaled-up video window may be dismissed, and a screen similar to user interface 100 may resume. In at least one embodiment, a recipient declining an invitation may specify some short explanatory text to be transmitted to the initiator. An interface may be provided to allow the recipient to select from generic hardcoded text (for example “Can't talk right now”) or to enter customized text.

In another embodiment, the full-resolution video call commences without first giving the recipient the opportunity to accept or reject the invitation.

In at least one embodiment, the full-resolution video call may be presented on the same display device as is used for the video presence information described above in connection with FIGS. 1 and 2, such as for example display screen 803. The full-resolution video call may replace the video presence information on display screen 803, or may be presented alongside the video presence information on display screen 803.

In another embodiment, multiple display screens 803 may be provided. An auxiliary display screen 803 may be used to display video presence information described above in connection with FIGS. 1 and 2, while device's 801 main display screen 803 may be used to display the full-resolution video call. In at least one embodiment, the auxiliary display screen 803 may be a dedicated video presence display screen 803 that is positioned adjacent to user's 800 computer, and may be a relatively small display screen 803. Video calls may be displayed on the main display screen 803, which may be the primary display screen 803 associated with user's 800 computer (or other device), and may be a larger screen than auxiliary display screen 800. In this manner, full-resolution video calls can be presented using higher-quality components such as a larger screen, better camera, better audio capture devices, and the like, while the lower-resolution components can be used for capturing and presenting video presence information. In addition, such an implementation may be helpful because the video presence information does not use screen real estate on the main display of the computing system.

In at least one embodiment, group video calls may be provided. Users 800 can knock multiple other users 800, who each can accept or decline the invitation to participate in the video call. In at least one embodiment, additional users 800 can be added to a video call in progress. In at least one embodiment, any participant in a video call may invite additional users 800. In all such situations, each invited user 800 (“recipient”) may be given the opportunity to accept or decline the invitation; while the invitation is pending, blurred video of the initiator may be presented to the recipient, and blurred video of the recipient may be presented to the initiator (and, optionally, to other users 800 already on the video call). A split screen or multi-window or multi-pane display can be used to display, to each user 800, the other users 800 on the video call or invited to the video call.

In at least one embodiment, a user 800 (“initiator”) may wish to join a video call already in progress between two or more other users 800 (“recipients”). In this case, the initiator may knock any of the recipients, and all recipients may then receive the initiation. In at least one embodiment, any of the recipients can accept or decline the invitation, causing the initiator to be added to the video call in progress, or causing the invitation to be dismissed. In at least one other embodiment, only the specific recipient who was knocked can accept or decline the invitation. If the invitation is declined, the original participants may continue their video call.

In at least one embodiment, before inviting a potential recipient to any video call, a user 800 can view indicator 108 corresponding to the potential recipient, thus ascertaining the status of the potential recipient and thereby obtaining some information as to their availability and likelihood to answer.

### Screen Sharing

In at least one embodiment, while in a full-resolution video call, users 800 can share their screens with one another. In at least one embodiment, the system improves on existing screen sharing functionality by providing a selective screen sharing option wherein certain screen elements (such as user controls) may be omitted from the shared screen. For example, if user A (the “sharer”) shares their screen with user B (the “sharee”), the sharer may elect to omit certain elements from the screen share, such as user interface elements intended only for the sharer. Such elements may include, for example, a button to exit the screen share, or to configure the sharer's screen, or information in other windows or panes. In this manner, the sharer can avoid sharing sensitive or confidential information. In addition, omitting extraneous elements from the shared screen can reduce confusion, for example by avoiding display of user interface elements that are not applicable to the sharee, or that the sharee cannot invoke, such as a button to exit the screen share.

In at least one embodiment, the system presents a control panel on the sharee's screen that may cover certain elements from the sharer's screen, such as user interface elements intended only for the sharer. In this manner a control panel relevant to the sharee may be shown on the sharee's screen, while a control panel relevant to the sharer may be shown on the sharer's screen. In at least one embodiment, the control panels on the sharee's and sharer's screens can be displayed in relatively the same location on each respective screen.

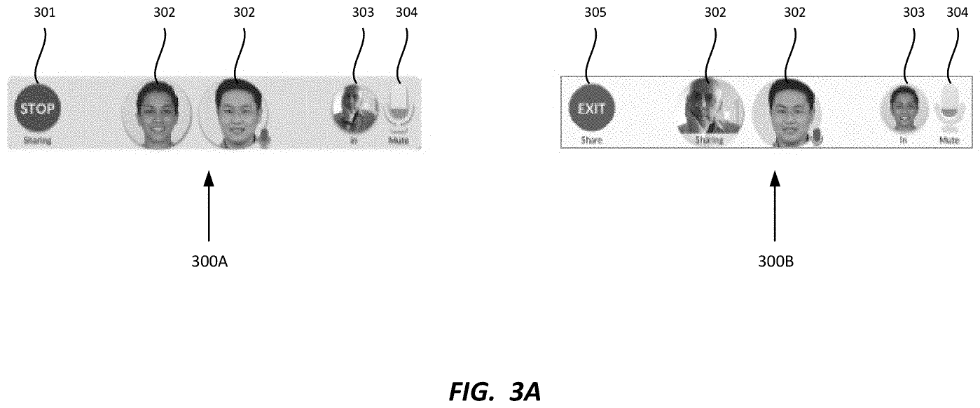

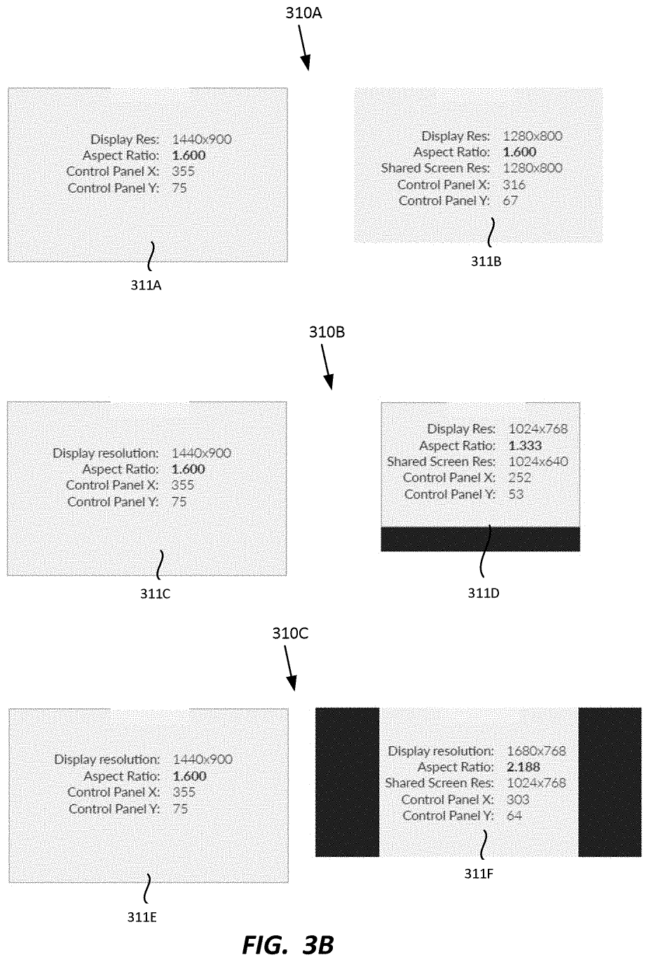

Referring now to FIG. 3A, there is shown a partial screenshot depicting examples of sharer control panel 300A and sharee control panel 300B that may be displayed when a screen is being shared during a video call according to one embodiment. Sharer control panel 300A may include thumbnails 302 representing other individuals on the call (sharees), as well as thumbnail 303 representing the sharer. Thumbnails 302 may be static images, or they may be live video feeds. Icon 304 may indicate whether or not the sharer is currently muted. Stop button 301 may provide a control for stopping the screen share. Sharee control panel 300B may include thumbnails 302 representing other individuals on the call (the sharer plus any other sharees), as well as thumbnail 303 representing the sharee. Icon 304 may indicate whether or not the sharee is currently muted. Exit button 305 may provide a control for exiting the screen share.

Notably, most elements of control panel 300A and control panel 300B may be substantially identical in appearance, position, and function. However, those element(s) of control panel 300A that are not applicable to the sharee (such as stop button 301) may be replaced on sharee's control panel 300B by other element(s) that may be applicable to the sharee.

In at least one embodiment wherein the aspect ratio of the sharer and sharee's screens may differ, positioning and/or size of control panels 300A, 300B may be adjusted as needed to account for such difference in aspect ratios. Referring now to FIG. 3B, there are shown various examples of aspect ratio conversion when sharing screens, according to one embodiment. In situation 310A, aspect ratios of sharer's screen 311A and sharee's screen 311B are the same; therefore the horizontal and vertical positions (represented by X and Y, respectively) of control panel 300B can be calculated from the horizontal and vertical positions of control panel 300A by simply multiplying the X and Y values by a scaling factor. The scaling factor may be determined by dividing the horizontal or vertical display resolution of sharee's screen 311B by the horizontal or vertical display resolution of sharer's screen 311A (both horizontal and vertical display resolutions will yield the same results).

In the example of situation 310A, the display resolution of sharer's screen 311A is 1440×900 pixels, while that of sharee's screen 311B is 1280×800 pixels. Therefore, the (X,Y) coordinates for control panel 300B on sharee's screen 311B may be determined by applying a scaling factor of (1280/1440=800/900=0.89) to the (X,Y) coordinates for control panel 300A on sharer's screen 311A. Accordingly, for sharer (X,Y) coordinates of (355,75), the sharee's (X,Y) coordinates may be determined as (316,67).

In situation 310B, the aspect ratio of the sharer's screen 311C is greater than that of sharee's screen 311D (i.e., X/Y is greater for sharer's screen 311C than for sharee's screen 311D). Thus, when displaying the contents of sharer's screen 311C on sharee's screen 311D, letterboxing may be applied to the top and/or bottom of the image. In this situation, the horizontal and vertical positions (represented by X and Y, respectively) of control panel 300B can be calculated from the horizontal and vertical positions of control panel 300A by multiplying the X and Y values by a scaling factor. The scaling factor may be determined by dividing the horizontal display resolution of sharee's screen by the horizontal display resolution of sharer's screen 311C. By only considering the horizontal display resolutions, the system thus allows for the blank area of sharee's screen 311D that has been introduced by the letterboxing. The vertical position may be adjusted by a constant if the display on sharee's screen 311D is vertically centered or otherwise vertically shifted from a top-left position on sharee's screen 311D.

In the example of situation 310B, the display resolution of sharer's screen 311C is 1440×900 pixels, while that of sharee's screen 311D is 1024×768 pixels. Therefore, the (X,Y) coordinates for control panel 300B on sharee's screen 311D may be determined by applying a scaling factor of (1024/1440=0.71) to the (X,Y) coordinates for control panel 300A on sharer's screen 311D. Accordingly, for sharer (X,Y) coordinates of (355,75), the sharee's (X,Y) coordinates may be determined as (252,53).

In situation 310C, the aspect ratio of sharer's screen 311E is less than that of sharee's screen 311F (i.e., X/Y is less for sharer's screen 311E than for sharee's screen 311F). Thus, when displaying the contents of sharer's screen 311E on sharee's screen 311F, letterboxing may be applied to the left and/or right sides of the image. In this situation, the horizontal and vertical positions (represented by X and Y, respectively) of control panel 300B can be calculated from the horizontal and vertical positions of control panel 300A by multiplying the X and Y values by a scaling factor. The scaling factor may be determined by dividing the vertical display resolution of sharee's screen 311F by the vertical display resolution of sharer's screen 311E. By only considering the vertical display resolutions, the system thus allows for the blank area of sharee's screen that has been introduced by the letterboxing. The horizontal position may be adjusted by a constant if the display on sharee's screen 311F is horizontally centered or otherwise horizontally shifted from a top-left position on sharee's screen 311F.

In the example of situation 310C, the display resolution of sharer's screen 311E is 1440×900 pixels, while that of sharee's screen 311F is 1680×768 pixels. Therefore, the (X,Y) coordinates for control panel 300B on sharee's screen 311F may be determined by applying a scaling factor of (768/900=0.853) to the (X,Y) coordinates for control panel 300A on sharer's screen 311E. Accordingly, for sharer (X,Y) coordinates of (355,75), the sharee's (X,Y) coordinates may be determined as (303,64).

As described above, in at least one embodiment, control panels 300A, 300B may include thumbnails 302 of participants on the call, which may be static images or live video feeds. Since there may be a variable number of participants in the video call, control panels 300A, 300B may be dynamically sized to account for this variable number. In some embodiments, the width of control panels 300A, 300B may automatically increase when more participants are on the call, to provide more space for the additional thumbnails 302. In at least one embodiment, the width of each control panel 300A, 300B may start with a base value as determined according to the techniques described above, plus any additional width that may be needed to display thumbnails 302 for additional participants. In at least one embodiment, a maximum width may be established, so that if the number of participants exceeds a certain amount such that thumbnails 302 will not fit within the established maximum, any additional thumbnails 302 may be omitted, displayed in an additional row, or be available for display via scrolling.

### Badges

In at least one embodiment, the software application that implements the techniques described herein may operate in a “minimized” mode, wherein it may occupy minimal (or no) screen space on the user's device. One issue with such an operating mode is that the user may forget that the application is running, and may not make use of the presence information available via the application.

In at least one embodiment, while the application is running in minimized mode, an icon representing the software application may be presented in a dock or taskbar, for example at the bottom or side of the screen. A badge may be included in the icon (or presented adjacent to the icon), to indicate the number of other people currently designated as “present” within the group or virtual space (such as in the workplace or other environment the user is currently occupying).

In at least one embodiment, the badge may include a numeric indicator indicating the number of people currently designated as present within the group or virtual space, including the user. However, if the user is the only individual currently present in the group or virtual space, no badge may be included. In another embodiment, if the user is the only individual currently present in the group or virtual space, a badge including a numeric indicator of “1” may be included.

In yet another embodiment, the badge may include a numeric indicator indicating the number of other people currently designated as present within the group or virtual space, excluding the user. Again, if the user is the only individual currently present in the group or virtual space, no badge may be included.

When other users join or leave the group of those currently present, the numeric indicator may be automatically updated in real-time to reflect the current number of other users in the group or virtual space.

In at least one embodiment, when the user opens the software application (i.e., takes it out of minimized mode), the badge may be automatically removed from the icon representing the software application.

In at least one embodiment, when the user minimizes the software application after it has been opened, the icon may be displayed without any numeric indicator until another user joins or leaves the group of those currently present, at which time the numeric indicator may be updated to reflect the current number of other users in the group or virtual space. In another embodiment, when the user minimizes the software application after it has been opened, the icon may be displayed with a numeric indicator indicating the current number of other users in the group or virtual space.

Thus, in one example, the following sequence of events may take place with the numeric indicator being updated as follows:
The software application is initiated in minimized mode, and there are five people currently present in the group or virtual space: The application icon may be displayed in the taskbar or dock, including a badge with numeric indicator displaying “5” (since there are five people present in the group or virtual space).
The user opens the application: The badge may be removed from the application icon (since the badge may be dismissed when the user opens the application).
The user minimizes the application: No change to the application icon (still no badge) (since the badge may not be activated when the user closes the application).
One of the other people in the group or virtual space leaves: A badge with a numeric indicator displaying “4” may be added to the application icon (since there are now four people present in the group or virtual space).
One of the other people in the group or virtual space joins: The badge may be updated to include a numeric indicator displaying “5” (since there are now five people present in the group or virtual space).

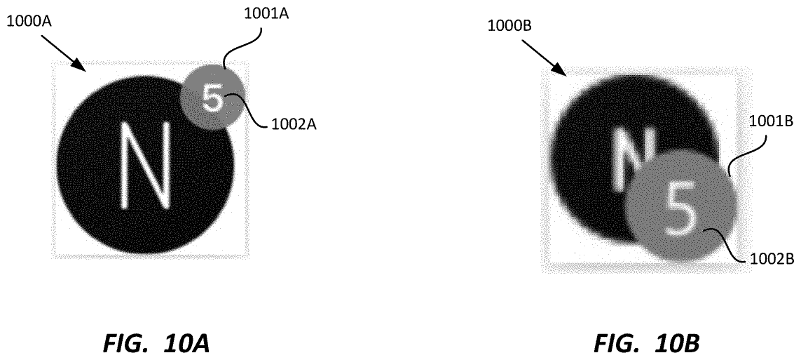

Referring now to FIG. 10A, there is shown an example of application icon 1000A including badge 1001A having numeric indicator 1002A, as it may appear in a dock within the MacOS operating system. Referring now to FIG. 10B, there is shown an example of application icon 1000B including badge 1001B having numeric indicator 1002B, as it may appear in a dock within the Windows operating system. One skilled in the art will recognize that these are merely examples, and that the application icon, badge, and/or numeric indicator can take any other suitable form.

### Use Cases

The techniques described herein can be applied in many contexts and environments. One such environment may be in an office or other workspace, wherein the described techniques can be used to provide presence information that simulates or evokes a physical office space with private offices having frosted glass doors or windows. However, one skilled in the art will recognize that the described techniques can also be used in many other situations, including but not limited to:
Elder parents who may live alone or remotely and want to stay connected with their remote adult children. The described techniques can be used to connect the elder parent's household to their child's (or children's) households, while maintaining privacy. This can provide comfort to both parties by presenting continuous, passive presence information (for limited time thanks to the availability hours function), assuring each party that the other party is present and available, as well as providing a simple mechanism for initiating high-resolution video calls.
Teachers or professors who want to hold remote office hours for students while maintaining privacy. The described techniques allows teachers and their students to instantly see availability and presence for virtual communication as if they were using a physical office.
Student work groups who may want to meet to collaborate for a short time and then go back to working individually. The described techniques allow each member of the group to work independently and in silence (or with their own audio setup), while still being connected to the rest of the group for quick one-on-one questions or group discussions.
Managers in a virtual or remote office environment may use the described techniques to provide a mechanism by which corporate culture can be imparted to newly onboarded remote employees, and to make sure the new employees have access to personnel (including their manager, peers, and/or other coworkers) for quick questions and short social interactions or conversations.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; MacOS, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for sharing presence information among a plurality of users within a group of users, connected via an electronic network, comprising:
establishing a group of users associated with a plurality of devices connected via the electronic network; and
at each of at least a subset of the devices within the plurality of devices:
ascertaining a presence status for a user associated with the device; and
responsive to the presence status indicating current presence of the user associated with the device:
capturing live video of the user via a camera associated with the device;
selectively applying a video effect to the live video that preserves the privacy of the user, to generate a modified video stream; and
transmitting, via the electronic network, the modified video stream to devices associated with other users within the group of users, for display on the devices associated with the other users as part of a display of live presence indicators comprising modified video streams of a plurality of users within the group.

2. The method of claim 1, wherein selectively applying the video effect to the live video that preserves the privacy of the user comprises selectively applying a video effect to the live video that partially obscures details of the user.

3. The method of claim 2, wherein selectively applying the video effect to the live video that partially obscures details of the user comprises selectively applying at least one of a pixelation and a blur effect to the live video.

4. The method of claim 2, wherein selectively applying the video effect to the live video that partially obscures details of the user comprises selectively applying a video effect that causes the modified video stream to require less bandwidth to transmit than would a video stream representing the original captured live video.

5. The method of claim 1, further comprising:
at each of at least a subset of the devices, displaying, on a screen, a plurality of live presence indicators comprising modified video streams of a plurality of users within the group.

6. The method of claim 5, further comprising:
for at least one of the users within the group, determining that the user belongs to a subcategory;
and wherein:
displaying the plurality of live presence indicators comprises, for each of at least a subset of the users, displaying the modified video stream of the user in an area of the screen associated with the subcategory containing the user.

7. The method of claim 6, wherein:
determining that the user belongs to a subcategory comprises determining that the user is associated with at least one of a plurality of virtual public spaces; and
displaying the modified video stream of the user in an area of the screen associated with the subcategory containing the user comprises displaying the modified video stream of the user in an area of the screen associated with one of the virtual public spaces.

8. The method of claim 7, wherein determining that the user is associated with at least one of a plurality of virtual public spaces comprises determining that the user has provided input indicating that the user is entering at least one of the virtual public spaces.

9. The method of claim 5, further comprising:
receiving user input from a user, via an input device, in connection with one of the displayed live presence indicators; and
responsive to the received user input, initiating a full-resolution video conversation between the user from whom the input was received as a first participant and a user associated with the displayed live presence indicator as a second participant.

10. The method of claim 9, further comprising:
responsive to receiving the user input from at least one of the participants requesting screen sharing with another of the participants, electronically displaying a representation of at least a part of a real-time display appearing on a screen of one of the participants on a screen of another of the participants.

11. The method of claim 10, wherein:
an aspect ratio of a screen of one of the participants differs from an aspect ratio of a screen of another of the participants; and
electronically displaying the representation of at least a part of the real-time display appearing on the screen of one of the participants on the screen of another of the participants comprises adjusting the aspect ratio of the representation to be suitable for display on the screen of the other of the participants.

12. The method of claim 10, wherein electronically displaying the representation of at least a part of the real-time display appearing on the screen of one of the participants on the screen of another of the participants comprises at least one selected from the group consisting of:
obscuring, in the displayed representation, at least one user interface element of the real-time display; and
replacing, in the displayed representation, at least one user interface element of the real-time display with a second user interface element.

13. The method of claim 5, further comprising:
receiving user input from a user, via an input device, in connection with one of the displayed live presence indicators; and
responsive to the received user input:
inviting a user associated with the displayed live presence indicator to participate in a full-resolution video conversation;
receiving a response from the user associated with the displayed live presence indicator; and
responsive to the received response indicating acceptance of the full-resolution video conversation, initiating the full-resolution video conversation between the user from whom the input was received and the user associated with the displayed live presence indicator.

14. The method of claim 5, further comprising:
at each of at least a subset of the devices, responsive to a software application for displaying the live presence indicators being in a minimized state:
displaying an icon representing the software application; and
displaying an indicator associated with the icon and dynamically indicating the number of users within the group.

15. The method of claim 1, further comprising:
displaying at each of at least a subset of the devices, a pane comprising a plurality of live presence indicators comprising modified video streams of a plurality of users within the group.

16. The method of claim 15, wherein the pane displayed at each device further comprises a live presence indicator comprising a modified video stream for the user associated with the device.

17. The method of claim 1, wherein ascertaining the presence status for the user associated with the device comprises:
receiving, via a user input device associated with the device, input from the user indicating whether or not the user should be indicated as present.

18. The method of claim 17, wherein receiving input from the user indicating whether or not the user should be indicated as present comprises receiving input selecting among an “in”, “out”, and “no video” status.

19. The method of claim 1, wherein ascertaining the presence status for the user associated with the device comprises automatically ascertaining the presence status by detecting physical presence of the user proximate to the device associated with the user.

20. The method of claim 1, further comprising:
at each of at least a subset of the devices within the plurality of devices, receiving user input specifying a schedule comprising certain dates and/or times at which the user associated with the device is to be considered present and certain dates and/or times at which the user associated with the device is to be considered not present;
and wherein ascertaining the presence status for the user associated with the device comprises automatically ascertaining the presence status based on the specified schedule.

21. The method of claim 1, further comprising, at each of at least a subset of the devices within the plurality of devices, responsive to the presence status indicating current presence of the user associated with the device:
capturing live audio of the user via a microphone associated with the device;
generating at least one of a numeric, graphical, and visual representation of the live audio; and
transmitting, via the electronic network, the representation of the live audio to devices associated with other users within the group of users, for display on the devices associated with the other users as part of a display of live presence indicators comprising visual representations of the live audio of a plurality of users within the group.

22. The method of claim 21, further comprising:
at each of at least a subset of the devices, displaying a plurality of live audio indicators comprising generated visual representations of the live audio of each of the users in the plurality of users.

23. The method of claim 1, wherein the group of users occupy a shared virtual space.

24. The method of claim 1, wherein the devices are located remotely with respect to one another.

25. A non-transitory computer-readable medium for sharing presence information among a plurality of users within a group of users, connected via an electronic network, comprising instructions stored thereon, that when performed by a hardware processor, perform the steps of:
establishing a group of users associated with a plurality of devices connected via the electronic network; and
at each of at least a subset of the devices within the plurality of devices:
ascertaining a presence status for a user associated with the device; and
responsive to the presence status indicating current presence of the user associated with the device:
causing live video of the user to be captured via a camera associated with the device;
selectively applying a video effect to the live video that preserves the privacy of the user, to generate a modified video stream; and
causing the modified video stream to be transmitted, via the electronic network, to devices associated with other users within the group of users, for display on the devices associated with the other users as part of a display of live presence indicators comprising modified video streams of a plurality of users within the group.

26. The non-transitory computer-readable medium of claim 25, wherein selectively applying the video effect to the live video that preserves the privacy of the user comprises at least one selected from the group consisting of:
selectively applying a video effect to the live video that partially obscures details of the user;
selectively applying at least one of a pixelation and a blur effect to the live video; and
selectively applying a video effect that causes the modified video stream to require less bandwidth to transmit than would a video stream representing the original captured live video.

27. The non-transitory computer-readable medium of claim 25, further comprising instructions stored thereon, that when performed by a hardware processor, perform the steps of, at each of at least a subset of the devices within the plurality of devices, responsive to the presence status indicating current presence of the user associated with the device:
causing live audio of the user to be captured via a microphone associated with the device;
generating at least one of a numeric, graphical, and visual representation of the live audio; and
causing the representation of the live audio to be transmitted, via the electronic network, to devices associated with other users within the group of users, for display on the devices associated with the other users as part of a display of live presence indicators comprising visual representations of the live audio of a plurality of users within the group.

28. The non-transitory computer-readable medium of claim 25, wherein the devices are located remotely with respect to one another.

29. A system for sharing presence information among a plurality of users within a group of users, connected via an electronic network, comprising:
a processor, configured to establish a group of users associated with a plurality of devices connected via the electronic network; and
at each of at least a subset of the devices within the plurality of devices:
a presence module, configured to ascertain a presence status for a user associated with the device;
a camera, communicatively coupled to the presence module and associated with the device, configured to, responsive to the presence status indicating current presence of the user associated with the device, capture live video of the user;
a video effect module, communicatively coupled to the camera, configured to selectively applying a video effect to the live video that preserves the privacy of the user, to generate a modified video stream; and
a network interface module, communicatively coupled to the video effect module, configured to transmit the modified video stream, via the electronic network, to devices associated with other users within the group of users, for display on the devices associated with the other users as part of a display of live presence indicators comprising modified video streams of a plurality of users within the group.

30. The system of claim 29, wherein selectively applying the video effect to the live video that preserves the privacy of the user comprises at least one selected from the group consisting of:
selectively applying a video effect to the live video that partially obscures details of the user;
selectively applying at least one of a pixelation and a blur effect to the live video; and
selectively applying a video effect that causes the modified video stream to require less bandwidth to transmit than would a video stream representing the original captured live video.

31. The system of claim 29, further comprising, at each of at least a subset of the devices within the plurality of devices:
a microphone, associated with the device and configured to capture live audio of the user; and
a processor, communicatively coupled to the microphone, configured to generate at least one of a numeric, graphical, and visual representation of the live audio;
and wherein the network interface module is further configured to transmit the representation of the live audio, via the electronic network, to devices associated with other users within the group of users, for display on the devices associated with the other users as part of a display of live presence indicators comprising visual representations of the live audio of a plurality of users within the group.

32. The system of claim 29, wherein the devices are located remotely with respect to one another.
